(19) United States
(12) Patent Application Publication
(10) Pub. No.: US 2022/0044251 A1
(43) Pub. Date: Feb. 10, 2022

(54) SYSTEMS AND METHODS FOR USE IN IDENTIFYING NETWORK INTERACTIONS

(71) Applicant: MASTERCARD INTERNATIONAL INCORPORATED, PURCHASE, NY (US)

(72) Inventors: Mohamed Abouelenin, San Carlos, CA (US); Rajat Maheshwari, Singapore (SG); Anthony Lopreiato, Scarsdale, NY (US)

(21) Appl. No.: 17/387,574

(22) Filed: Jul. 28, 2021

Related U.S. Application Data
(60) Provisional application No. 63/061,591, filed on Aug. 5, 2020.

(51) Int. Cl. G06Q 20/40

(52) U.S. Cl. CPC G06Q 20/40145; G06Q 20/405; G06Q 20/40155

(57) ABSTRACT

Systems and methods are provided for identifying types of network interactions. An example method includes generating, by a token service provider, a token for a payment account based on a request from a user, where the token includes an indicator of a type of transaction for which the token is available for use, and provisioning, by the token service provider, the token to a third party. In doing so, in response to use of the token in a transaction to the payment account, the indicator is included at a first data element of an authorization request for the transaction to the payment account thereby identifying the type of the transaction in the authorization request.

### CROSS-REFERENCE TO RELATED APPLICATION

This application claims the benefit of, and priority to, U.S. Provisional Application No. 63/061,591, filed Aug. 5, 2020. The entire disclosure of the above application is incorporated herein by reference.

### FIELD

The present disclosure generally relates to systems and methods for use in identifying network interactions and, in particular, to systems and methods for use in identifying particular types of network interactions associated with presentment of certain user credentials and/or involving certain user verification.

### BACKGROUND

This section provides background information related to the present disclosure which is not necessarily prior art.

It is known for users to interact with third parties for a variety of purposes. For example, a user may present a payment card to a merchant to fund a purchase of goods from the merchant, via an account associated with the card. Alternatively, the user may present a virtual wallet to the merchant, which includes a token associated with the same account, in lieu of the card, whereby, again, the transaction is funded by the account associated with the card. In connection therewith, the user may also present an identity credential to the merchant, thereby permitting the merchant to have an assurance that the user is an authorized user of the card or virtual wallet (broadly, the account) and that the user is who she/he says she/he is. Such identity credential may include a personal identification number (PIN), a password, a signature, a biometric, etc. In addition to the merchant requiring such assurance, an issuer of the user's account may also impose restrictions on the account based on the identity credential presented by the user, or not, with the card or virtual wallet. For example, the issuer may specifically require the user to present a PIN for a debit transaction and a passcode for a card-not-present transaction, in order to provide assurance to the issuer that the user is authorized.

### DRAWINGS

The drawings described herein are for illustrative purposes only of selected embodiments and not all possible implementations, and are not intended to limit the scope of the present disclosure:

FIG. 1 illustrates an example system for use in identifying particular types of network interactions associated with presentment of certain user credentials and/or involving certain user verification;

FIG. 2 is a block diagram of an example computing device that may be used in the system of FIG. 1;

FIG. 3 illustrates an example method that may be implemented via the system of FIG. 1, for use in identifying particular types of network interactions; and

FIG. 4 illustrates another example method that may be implemented in the system of FIG. 1, for use in identifying particular types of network interactions and assurances associated therewith.

Corresponding reference numerals indicate corresponding parts throughout the several views of the drawings.

### DETAILED DESCRIPTION

Example embodiments will now be described more fully with reference to the accompanying drawings. The description and specific examples included herein are intended for purposes of illustration only and are not intended to limit the scope of the present disclosure.

Users may present payment accounts in a variety of different manners to merchants, to fund purchase transactions (broadly, network interactions) by the users at the merchants, including, for example, via payment cards, virtual wallets, biometrics, cards-on-file, etc. In connection with the transactions, the users may, or may not, be required or solicited to enter/provide identity credentials to the merchants (e.g., PINs, biometrics, etc.), whereby identities of the users may be verified. In one example, as part of initiating a transaction at a merchant, a biometric of a user may be captured by a point-of-sale (POS) terminal and compared to a reference biometric stored at a card associated with an account of the user. The transaction may then be permitted when there is a sufficient match. In general, however, when merchants submit authorization requests for transactions, the authorization requests include limited information about how user accounts where identified to/by the merchants, and whether any identity credentials were also presented by users performing the transactions. Presently, authorization requests may include card-present or card-not-present (CNP) indications. As such, the authorization requests provide limited insight for issuers and other parties to the transactions to assess the assurances associated with the transactions, or at least to identify the types of transactions and the manners of verifying the users, if any.

Uniquely, the systems and methods herein permit authorization requests to be modified and/or enhanced to include additional data related to particular types of network interactions, whereby parties associated with the authorization requests for the network interactions are more informed about risks associated with the network interactions.

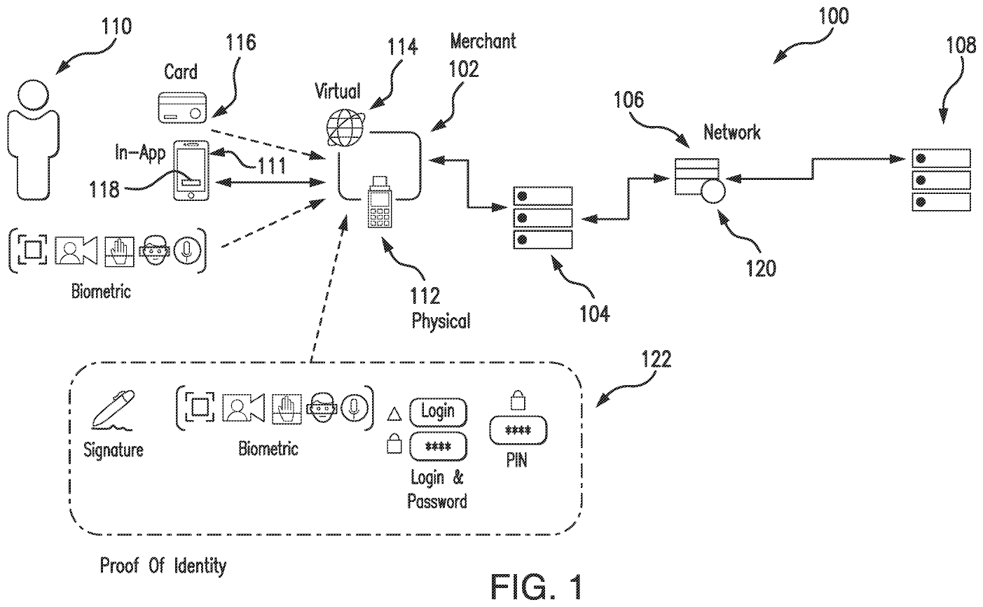

FIG. 1 illustrates an example system 100 in which one or more aspects of the present disclosure may be implemented. Although parts of the system 100 are presented in one arrangement, it should be appreciated that other example embodiments may include the same or different parts arranged otherwise depending on, for example, types of transactions, availability of identifying credentials for users, privacy concerns and/or regulations, etc.

As shown in FIG. 1, the illustrated system 100 generally includes a merchant 102, an acquirer 104, a payment network 106 and an issuer 108 of payment accounts, each coupled to (and each in communication with) one or more networks, as indicted by the arrowed lines. Each of the one or more networks may include, without limitation, a wired and/or wireless network, a local area network (LAN), a wide area network (WAN) (e.g., the Internet, etc.), a mobile network, and/or another suitable public and/or private network capable of supporting communication among two or more of the illustrated components of the system 100, or any combination thereof. One or more of the networks may further be segregated or separated, whereby, for example, the segregated or separated network(s) may include a private payment transaction network provided by the payment network 106 to the acquirer 104 and the issuer 108, and separately, a public network (e.g., the Internet, etc.) through which the merchant 102 and/or a user 110 (i.e., a communication device 111 (e.g., a mobile device such as a smart phone, tablet, etc.) associated therewith) communicate, or through which the merchant 102 communicates with the acquirer 104, payment network 106, and/or the issuer 108, etc.

In this example embodiment, the merchant 102 is associated with products offered for sale and sold to the user 110, for example, and other users. The merchant 102 may be available to the user 110 at a physical location, whereby a terminal 112 may be employed to interact with the user 110, or a virtual location 114, whereby the user interacts with the merchant 102 via the communication device 111 (or other computing device). The physical location may be a brick-and-mortar store, while the virtual location 114 may include a website or network-based application (to enable in-app transactions, etc.) at the user's communication device 111, etc. In general, the user 110 will be present for a transaction at the physical location, and away from the merchant 102 for a transaction with the virtual location 114.

The acquirer 104 is a bank or other financial institution, which is configured to issue an account to the merchant 102. The account is the destination for funds paid to the merchant 102, for example, via payment account transactions, etc. Similarly, the issuer 108 is a bank or other financial institution, which is configured to issue an account (e.g., a credit account, a debit account, a prepaid account, etc.) to the user 110. As described herein, the account of the user 110 is the source of the funds paid to the merchant 102, for example, via payment account transactions performed by the user 110 at the merchant 102.

The payment network 106 is coupled in communication between the acquirer 104 and the issuer 108, and is configured to provide for communication therebetween, for purposes of authorization, clearing and settlement of transactions performed at the merchant 102, etc. (broadly, for processing the transactions). The transactions (as well as other transactions in the system 100) are each facilitated through an authorization request, generated by the merchant 102 and communicated through the acquirer 104 and the payment network 106, to the issuer 108, and through an authorization reply generated by the issuer 108 and communicated back to the merchant 102, as described below. The authorization request and the authorization reply generally abide by the ISO 8583 standard. The payment network 106 also includes a token service provider 120, which is configured to provision tokens for payment accounts, upon request, etc. The token service provider 120 may include, for example, the Mastercard® Digital Enablement service (MDES), etc.

Also in this embodiment, the user 110 is associated with a payment device, which is linked to the account issued to the user 110 by the issuer 108. In particular, in the illustrated embodiment, the payment device is in the form of a card device 116 (e.g., a credit card, a debit card, etc.) and a virtual credential 118 (e.g., as stored in a virtual wallet application at the communication device 111, etc.) (referred to herein as “in-app”). The card device 116 may be an EMV-enabled card device (e.g., as described at www.emco.com/, etc.), or not. What's more, the account linked to the payment device may be provisioned, as a token, via the token service provider 120 (or other token service provider), to one or more additional devices or to a biometric associated with the user 110. For example, the user 110 may provision the account to a biometric of the user 110 (e.g., a palm print, etc.) (e.g., via a token linked to the account and the biometric, etc.), via a suitable provisioning process, whereby the biometric may be used to initiate a transaction in lieu of the payment device. The account may also (or alternatively) be provisioned to a computer-readable indicia, such as a QR code or barcode, etc., which may be presented at the merchant 102, and which may include a primary account number (PAN) for the account or which may be linked to the account via a token. Further, such a token linked to the account may be issued to the user 110 by the issuer 108, and may be provisioned to the merchant 102 (or another third party) for initiating card-on-file transactions (e.g., as an on-file token, etc.) (e.g., for user-directed transactions, recurring transactions, etc.).

In addition to the payment device, the user 110 is further associated with one or more forms of proof of identity 122. The proof of identity 122 may include, without limitation, a signature, a biometric (e.g., a fingerprint, a facial image, a palm print, a retina print, a voice print, etc.), login credentials, and PINs/passcodes, etc. In general, the proof of identity 122 is in the possession of the user 110 (e.g., a biometric at the communication device 111, at the card device 116, etc.) or is known to the user 110 (e.g., a password, a PIN, one or more passcodes, etc.).

In general, when the account is issued to the user 110, the issuer 108 may be configured to collect one or more forms of the proof of identity 122. Additionally, or alternatively, the issuer 108 or the token service provider 120 or another entity involved in the transaction, may be configured to collect one or more forms of the proof of identity 122 in connection with a registration and/or a provisioning of one or more tokens, etc.

While only one merchant 102, one acquirer 104, one payment network 106, one issuer 108 and one token service provider 120 are shown in FIG. 1, it should be appreciated that additional instances of these entities or other entities may be included in other system embodiments. Moreover, only one user 110 is illustrated herein, while system embodiments will general include a number of users, each associated with an accounts as described above, for funding transactions with one or more merchants.

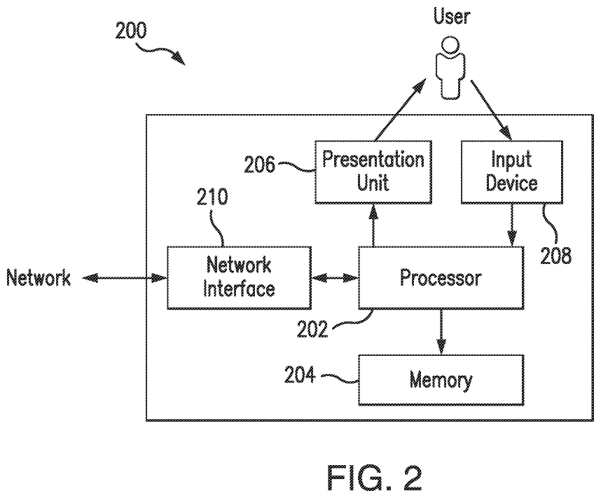

FIG. 2 illustrates an example computing device 200 that can be used in the system 100. The computing device 200 may include, for example, one or more servers, workstations, personal computers, laptops, tablets, smartphones, point-of-sale (POS) terminals, payment devices, etc. In addition, the computing device 200 may include a single computing device, or it may include multiple computing devices located in close proximity, or multiple computing devices distributed over a geographic region, so long as the computing devices are specifically configured to function as described herein. In at least one embodiment, the computing device 200 is accessed (for use as described herein) as a cloud, fog and/or mist type computing device. In the system 100, the merchant 102 (and the terminal 112), the acquirer 104, the payment network 106, the issuer 108, and the token service provider 120 may each include and/or be considered one or more computing devices, which may include or be consistent, in whole or in part, with the computing device 200. With that said, the system 100 should not be considered to be limited to the computing device 200, as described below, as different computing devices and/or arrangements of computing devices may be used. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204 may be configured to store, without limitation, proofs of identity, payment account credentials (e.g., PANs, tokens, etc.), assurance indicators, and/or other types of data (and/or data structures) suitable for use as described herein.

Furthermore, in various embodiments, computer-executable instructions may be stored in the memory 204 for execution by the processor 202 to cause the processor 202 to perform one or more of the functions described herein (e.g., one or more of the operations recited in the methods herein, etc.), such that the memory 204 is a physical, tangible, and non-transitory computer readable storage media. Such instructions often improve the efficiencies and/or performance of the processor 202 and/or other computer system components configured to perform one or more of the various operations herein, whereby upon executing such instructions the computing device 200 operates as (or transforms into) a specific-purpose device configured to then effect the features described herein. It should be appreciated that the memory 204 may include a variety of different memories, each implemented in one or more of the functions or processes described herein.

In the example embodiment, the computing device 200 also includes an presentation unit 206 that is coupled to (and that is in communication with) the processor 202. The presentation unit 206 outputs information, such as solicitations to enter a PIN/passcode, etc., visually, for example, to the user 110 or other information to other users associated with any of the entities illustrated in FIG. 1, at a respective computing device, etc. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

In addition, the computing device 200 includes an input device 208 that receives inputs from the user (i.e., user inputs) such as, for example, entry of proofs of identity, payment account credentials, etc., from the user 110 or other information from other users in the system, etc. The input device 208 may include a single input device or multiple input devices. The input device 208 is coupled to (and is in communication with) the processor 202 and may include, for example, one or more of a keyboard, a pointing device, a mouse, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

Further, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks and/or one or more other computing devices herein.

Referring again to FIG. 1, the system 100 is provided to include an indication or description of a transaction type, for example, in an authorization request generated by the merchant 102 for a transaction initiated by the user 110 and transmitted by the merchant 102 to the acquirer 104. In connection therewith, as the authorization request is communicated to the payment network 106 and the issuer 108, it provides added options to these entities in participating in the transaction. Various implementations consistent therewith are described below.

In a first implementation of the system 100, the user 110 requests the token service provider 120 to provide a tokenization of a credential (e.g., a PAN, an expiration date, etc.) for the user's payment account, for a specific type of transaction, for example, a biometric identity transaction, a card-on-file transaction, an in-app transaction, etc. (in which the token is available or use and/or in which the token may be used). In response, the token service provider 120 is configured to capture the credential associated with the user's payment account, the type of transaction, and other data as necessary or desired. Thereafter, the token service provider 120 is configured to generate a token, or more specifically, a token profile for the user 110, and the specific type of transaction, and to provision the token profile for the account (e.g., either locally in memory of the token service provider 120, at a third party (e.g., a merchant server, a backend server, etc.), etc.).

In this example, the token profile includes a segment indicative of the specific type of transaction indicated by the user 110 (and requested by the user, in this example). In particular, the token profile is associated with a tag configured to be added to an Application Interchange Profile (AIP) data element (DE), at byte 2, bit 2, of authorization requests relating to transactions performed by the user 110 via the token profile.

As such, after the token profile is provisioned, when a transaction is initiated with the token profile at the physical location of the merchant 102, the terminal 112 is configured to populate the AIP DE tag into an authorization request for the transaction, and to also generate and populate a cryptogram based thereon into the authorization request. The authorization request thus generally includes the token, and an indication of the type of transaction (which is also in a cryptogram). It should be appreciated that the authorization request is generated, herein, consistent with the ISO 8583 standard, but it should be further appreciated that the authorization request may be consistent with other standards in other embodiments.

The terminal 112 is configured to then transmit the authorization request to the acquirer 104. Upon receipt, the acquirer 104 may be configured to read the AIP DE from the authorization request in order to determine a type of the transaction, or not. In the former, upon reading the AIP DE, the acquirer 104 may be further configured to modify the authorization request to indicate the type of the transaction. Specifically, in this example, the acquirer 104 may be configured to modify DE 22, subfield 1:POS Entry mode, DE 61, subfield 4: cardholder presence, and/or DE 61, subfield 4, card presence, to include the type of the transaction (based on the tag included in the AIP DE) in a manner recognizable by the payment network 106 and/or the issuer 108. This may also allow the acquirer 104 to apply one or more rules to the transaction and/or the merchant 102 relating to fraud detection, etc.

Alternatively, upon receipt of the authorization request, the acquirer 104 may be configured to pass the authorization request to the payment network 106 without modifying the authorization request to include a type of the transaction. In turn, the acquirer 104, whether after modifying the authorization request or not, is configured to submit (or transmit) the authorization request to the payment network 106.

When received at the payment network 106, because the authorization request includes the token, the payment network 106 is configured to direct the authorization request, or part thereof, to the token service provider 120. In turn, the token service provider 120 is configured to identify the PAN for the token (and to append the PAN to the authorization request) and to confirm the transaction type. In particular, for example, the token service provider 120 is configured to confirm the cryptogram (e.g. by generating a cryptogram (based on contents of the authorization request) and compare the generated cryptogram to the cryptogram in the authorization request (i.e., match is confirmed), etc.), thereby indicating the transaction type is unchanged. Once confirmed, the token service provider 120 is further configured to modify the authorization request to further indicate the type of the transaction (if not already done by the acquirer 104). For example, consistent with the above, the token service provider 120 may be configured to modify DE 22, subfield 1:POS Entry mode, DE 61, subfield 4: cardholder presence, and/or DE 61, subfield 4, card presence, to include the type of the transaction in a manner recognizable by the payment network 106 and/or the issuer 108. It should be appreciated that the transaction type may be indicated in a different data element, or combination of data elements, other than those listed, in other embodiments (e.g., data element 48, subfield 21: Acceptance data, data element 48, subfield 52: Transaction integrity class, etc.), although some data element changes may require certain approvals and/or modification of aspects of the system 100 (e.g., the terminal 112, etc.). If the authorization request is modified, in this manner, by the acquirer 104, the token service provider 120 is configured to then provide the authorization request to the issuer 108, via the payment network 106.

The issuer 108 is then configured to rely, at least on part, on the transaction type to approve or decline the transaction (and potentially, to shirk risk associated with the transaction in connection therewith). It should be appreciated that, in this manner, the issuer 108 and other parties associated with the authorization request, may be informed of the transaction type, generally without modifying operation of the terminal 112, and potentially, the acquirer 104 (depending on the data elements, subfields implicated, etc.), etc.

In a second implementation of the system 100, the token service provider 120 may be configured to provide data beyond the transaction type, including, for example, details associated with the transaction type and/or an assurance score for the tokenization of the payment account, etc.

In particular, in this implementation, the user 110 may again request the token service provider 120 to provide tokenization of credentials for a payment account (e.g., the PAN, etc.), whereby the request is associated with certain factors for the account, etc. As such, the request includes the payment account credential, a credential source (e.g., a magstripe card, a chip card, a computing device, a card on file, a manual or automated entry, etc.) and a credential authentication type (e.g., a chip cryptogram, a card-on-file cryptogram, a card verification code (CVC) from the card device 116, magstripe (MST) dynamic data, DVTC validation data, or none, etc.). The request may further include an indication of how the user 110 was identified/verified (e.g., via a PIN, a signature, a biometric, enhanced authentication (e.g., 3D Secure or 3DS processes, etc.), a one-time-passcode (OTP), a login credential, a physical ID check (e.g., driver's license, etc.), an address verification service (AVS), or none, etc.), and a user validation type (e.g., validation entity identity and/or type, validation score, etc.).

It should be appreciated that the factors above relate to a tokenization, and potentially, not the later use of the token (although some of the factors could relate to both). For example, a credential may be presented, via a chip card, where the user 110 is verified through 3DS, yet the token is intended for use as a biometric identity.

In response to the request, the payment network 106, and potentially, the token service provider 120, is configured to receive the request and to set an assurance level for the payment account credential. Specifically, the token service provider 120 may assign an assurance level based on one or more rules, such as by the example rules described in Table 1. The assurance level may, of course, includes other values, colors, symbols, etc., indicative of a relative assurance of the different requests for tokenization, i.e., that the user 110 is who he/she says he/she is, and also authorized for the credential, etc.

TABLE 1

| | | | | User | |
|---|---|---|---|---|---|
| Use | Credentials | Credentials | Credentials | Verification | |
| Case | Assurance | Source | Authentication | Method | 3DS Data |
| Card Chip & | High | Card Chip | ARQC | PIN | None |
| PIN | | | | | |
| Card Mag | High | Mag Stripe | None | Signature | None |
| Stripe & | | | | | |
| Signature | | | | | |
| Web based | No | Manual | CVC2 | 3DS-2 | Yes- |
| E-commerce | | Entry | | Factor | Authorization |
| Guest | | | | | Request |
| Checkout | | | | | |
| w/ 3DS step up | | | | | |
| Wallet NFC | High | Device SE | ARQC | Biometric- | None |
| | | | | Device | |
| Wallet In-App | High | Device SE | DSRP-UCAF | Biometric- | None |
| | | | | Device | |
| Uber Card on | No | Card on | None | Merchant | None |
| File (FPAN) | | File | | Identified | |
| Uber Card on | Low | Card on | DSRP-UCAF | Merchant | None |
| File (Token) | | File | | Identified | |
| App Based | No | Card on | None | Merchant | None |
| Fuel Purchase | | File | | Identified | |
| (FPAN) | | | | | |
| Biometric | Low | Card on | ARQC | Biometric- | None |
| Identity | | File | | Cloud | |

The payment network 106, and potentially, the token service provider 120, is configured to then generate the token, as requested by the user 110, to store the token in memory (e.g., the memory 204, etc.), and further to associate the assurance level with the token, whereby the assurance level is accessible via the token.

Thereafter, when a transaction is initiated with the token profile, the terminal 112 (or the virtual location 114) is configured to solicit a PIN, a passcode, or a biometric; engage in enhanced authentication; request login credentials, etc. The particular interaction of the terminal 112 (or the virtual location 114) is generally defined consistent with the token provided for the transaction, access to the token, and/or capabilities of the merchant 102, etc. For example, the terminal 112 may be configured to interact with a merchant plug-in (MPI) (not shown) to pursue authentication of the user 110 consistent with 3DS enhanced authentication and to receive a response therefrom. The terminal 112 may be configured to interact with one or more parties, or the card device 116, for biometric authentication. It should further be appreciated that the virtual location 114 may be similarly configured.

Next, the terminal 112 (or virtual location 114) is configured to generate an authorization request for the transaction, including the token and details of the transaction. For example, a credential source, a credential authentication type (e.g., a chip cryptogram, a card-on-file cryptogram, a card verification code (CVC) from the card device 116, magstripe (MST) dynamic data, DVTC validation data, or none, etc.), an indication of how the user was identified/verified and a user validation type may be included in the authorization request at one or more data element included therein. Table 2 includes example information that may be included in the authorization request, fields of the authorization request in which the information may be provided (e.g., the data element (DE), the sub-field (SF), the sub-element (SE), etc.), and new values for the information (to be included in the field(s) of the authorization request). Again, the terminal 112 (or the virtual location 114) is configured to generate the authorization request consistent with the ISO 8583 standard, but it should be further appreciated that the authorization request may be consistent with other standards in other embodiments.

TABLE 2

| New Information | Field | Information Value |
|---|---|---|
| Terminal PAN Entry | Existing field: | Add new value: 50 = Identity Based Credentials |
| Mode | DE 22, SF 1 | on File |
| Card Acceptor | Existing field: | Add new Value: C = Transaction has been |
| Terminal ID | DE 41, SE 29 | initiated on premises and complete remotely; |
| | | D = Transaction has been initiated off- |
| | | premises and complete remotely |
| Token Assurance | Add new | 0 = None; 1 = Low; 2 = Medium; 3 - High |
| Level | field(s) | |
| Biometric Type | Add new | Device Based; Cloud Based |
| | field(s) | |
| Biometric Method | Add new | Fingerprint; Facial Recognition; Palm; Iris; |
| | field(s) | Voice; Other |
| Cardholder Validation | Add new | 0-10 (None-Highest Validation) |
| Risk Score | field(s) | |
| Cardholder Validation | Add new | Issuer Validated; Merchant Validated; Third |
| Entity | field(s) | Party Validated; 3DS Validated |
| Validation Entity ID | Add new | 8 Character Random Identifier |
| | field(s) | |

The terminal 112 is configured to then transmit the authorization request with the token to the acquirer 104. Upon receipt, the acquirer 104 is configured to submit the authorization request to the payment network 106.

In this implementation, when received at the payment network 106, because the authorization request includes a token, the payment network 106 is configured to direct the authorization request, or part thereof, to the token service provider 120. In turn, the token service provider 120 is configured to identify the PAN for the token (and to append the PAN to the authorization request) and to retrieve the assurance level associated with the token. The token service provider 120 is configured to then append the assurance level, or a derivative of the assurance level after being combined with other data included in the authorization request (e.g., a credential source, a credential authentication type, an indication of how the user was identified/verified and finally, a user validation type, CNP indicator, etc.), to the authorization request.

The token service provider 120 is configured to then provide the authorization request to the issuer 108, via the payment network 106.

In turn, the issuer 108 is configured to rely, at least in part, on the assurance level (or a derivative thereof) and/or the credential source, the credential authentication type, the indication of how the user was identified/verified, and the user validation type, etc., to approve or decline the transaction (and potentially, to skirt risk associated with the transaction in connection therewith). It should be appreciated that, in this manner, the issuer 108 and other parties associated with the authorization request may be informed of the transaction type and/or an associated assurance level, etc., whereby the issuer 108 and/or other parties are more informed about risks associated with the transactions.

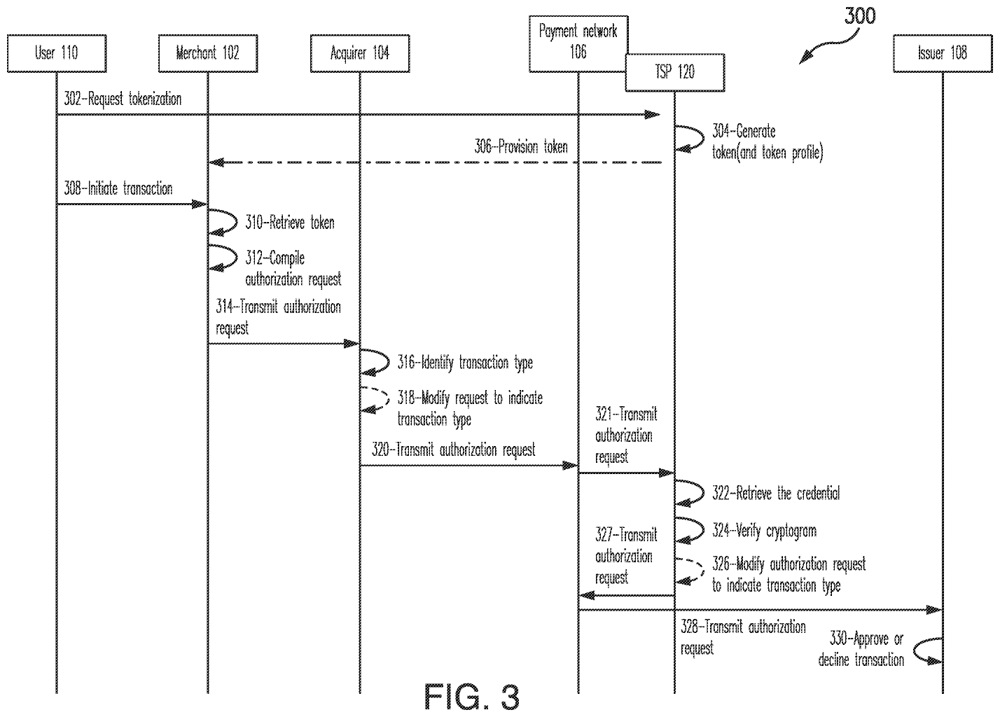

FIG. 3 illustrates an example method 300 for use in identifying types of network interactions. The example method 300 is described (with reference to FIG. 1) as generally implemented in the token service provider 120 (TSP 120 in FIG. 3) and other parts of the system 100, and with further reference to the computing device 200. As should be appreciated, however, the methods herein should not be understood to be limited to the example system 100 or the example computing device 200, and the systems and the computing devices herein should not be understood to be limited to the example method 300.

In the illustrated method 300, at 302, the user 110 requests tokenization of a credential (e.g., a PAN, etc.) associated with his/her payment account, from the token service provider 120.

In response, at 304, the token service provider 120 generates the token (and token profile). In particular, the token generally includes a card number for the card device 116 as derived from the funding PAN (FPAN). And, the token profile generally includes data associated with the token, as well as the AIP DE tag.

In connection therewith, the token service provider 120 includes an indicator (e.g. a specific bit or byte) of data in the AIP DE tag of the token profile, which is associated with tag D8 of the token profile, to indicate the type of transaction (e.g., user biometric identification supported, in-application pay at a terminal (e.g., pay at the pump for fuel merchants, etc.), etc.). The indicator will be included in a reserved part of the token profile. In general, in method 300, the indicator is included in a part of the token, or more generally, the token profile, as data that is included in the authorization request, by a merchant or other entity using the token (whereby alteration of the terminal at the entity is not required).

The token and token profile are then provisioned for use by the user 110. In doing so, the token may, optionally, be additionally provisioned, at 306 (as indicated by the dotted lines in FIG. 3), to the merchant 102 for use in card-on-file transactions with the merchant 102 (e.g., as an on-file token, etc.). Further, the token may be provisioned to the communication device 111 (or another device (e.g., a smartphone, a virtual wallet, a smartwatch, a fitness tracker, etc.)), or to another entity (e.g., a biometric identity transaction host (e.g., a token store and linked to a biometric to retrieve the token, etc.), etc.).

Once provisioned, the user 110 initiates a transaction with the merchant 102, at 308. The user 110 may provide the token, for example, through a virtual wallet, or provide a biometric associated with the token, whereby the merchant 102 is permitted to retrieve the token, or employ a merchant application to define the transaction (e.g., an in-application transaction, etc.). In response, the merchant 102 (e.g., the terminal 112, or the virtual location 114, etc.) retrieves (or receives), at 310, the token (and token profile) for the user's payment account (as provisioned above). In connection with the above, it should be appreciated that the user 110 may be requested to verify one or more proofs of identity 122 (e.g., by logging in to the merchant's virtual location 114, by responding to a challenge question associated with enhanced authentication, by providing a biometric, by providing a PIN, etc.), etc.

The merchant 102 then compiles an authorization request, at 312. In this example embodiment, the authorization request is consistent with the ISO 8583 standard, but may be consistent with one or more other interchange messaging standards, or otherwise, etc. In compiling the authorization request for the transaction, the merchant 102 includes the indicator (e.g., from tag D8 of the token profile, etc.) into the authorization request in data element 55. More specifically, as the indicator is part of the AIP DE tag, the indicator is compiled into a cryptogram specific to the transaction, and also included in the input data for the cryptogram, so that the cryptogram may be verified later. The cryptogram is based on, and the input data includes, for example, an authorized amount, a terminal country code, a terminal verification result, a transaction currency code, a transaction date, a transaction type, the AIP DE tag, etc. It should be appreciated that more or less data may be included in the token, as suited to a particular implementation, for example.

Once compiled, the merchant 102 transmits, at 314, the authorization request to the acquirer 104. The acquirer 104 identifies, at 316, the type of transaction from the AIP DE tag, as included in DE 55. Again, this may also allow the acquirer 104 to apply one or more rules to the transaction and/or the merchant 102 relating to fraud detection, etc. Optionally, as indicated by the dotted line in FIG. 3, the acquirer 104 may modify, at 318, the authorization request to include one or more additional indicators, at one or more data elements, as noted above, to convey the transaction type to the payment network 106 and/or the issuer 108.

In turn, the acquirer 104 transmits, at 320, the authorization request to the payment network 106, which passes, at 321, the authorization request to the token service provider 120, in response to the authorization request including the token.

At 322, the token service provider 120 retrieves the credential (e.g., PAN, etc.) for the token and appends the credential to the authorization request. In additional, the token service provider 120 verifies, at 324, the cryptogram, by generating the cryptogram, consistent with the merchant 102, based on the input data included in the authorization request. If the cryptograms match, the cryptogram is verified, and the token service provider 120 is informed that neither the input data nor the cryptogram is altered. Optionally, as indicated by the dotted line, the token service provider 120 may modify, at 326, the authorization request as needed to include one or more additional indicators, at one or more data elements, as noted above, to convey the transaction type to the issuer 108. In general, the token service provider 120 modifies the authorization request when the authorization request was not modified by the acquirer 104, at 318. The authorization request is then passed back to the payment network 106, at 327.

In response, the payment network 106 transmits, at 328, the authorization request to the issuer 108. Upon receipt, the issuer 108 decides, at 330, whether to approve or decline the transaction, based, at least in part, on the transaction type included in the authorization request. The issuer 108, in turn, compiles and transmits an authorization reply back to the merchant 102, via the payment network 106 and the acquirer 104. It should be appreciated that the transaction type may further be employed, amongst the issuer 108, the acquirer 104, or the payment network 106, to define or re-define the liability of the transaction for instances where the transaction is fraudulent.

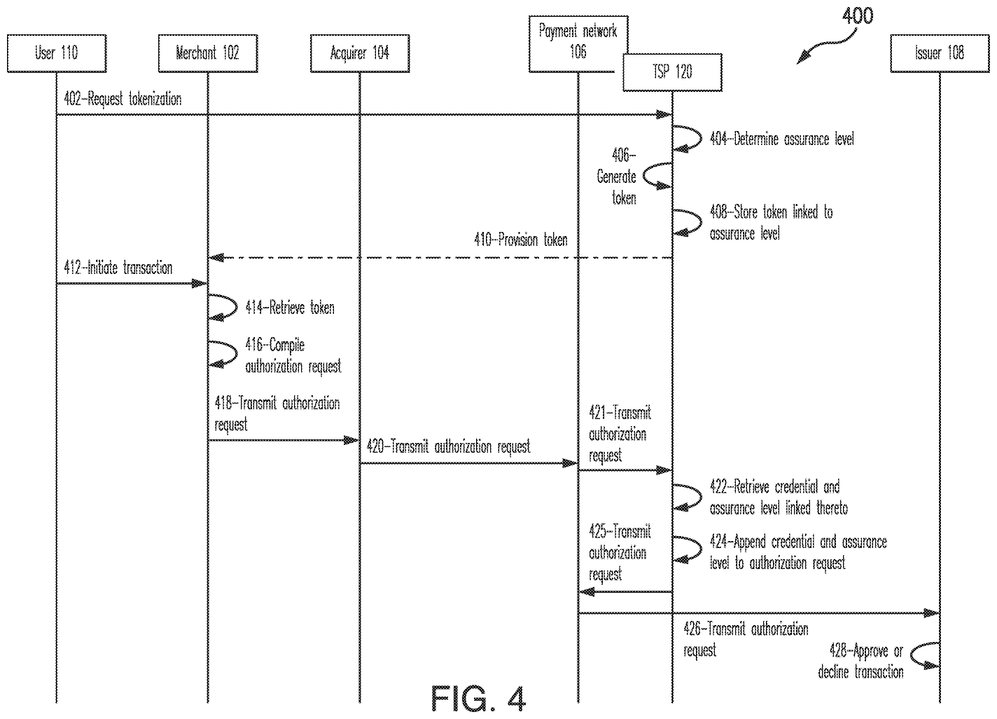

FIG. 4 illustrates another example method 400 for identifying types of network interactions. The example method 400 is described (with reference to FIG. 1) as generally implemented in the token service provider 120 (TSP 120 in FIG. 4) and other parts of the system 100, and with further reference to the computing device 200. As should be appreciated, however, the methods herein should not be understood to be limited to the example system 100 or the example computing device 200, and the systems and the computing devices herein should not be understood to be limited to the example method 400.

In the illustrated method 400, at 402, the user 110 requests tokenization of a credential (e.g., a PAN, etc.) associated with his/her payment account, from the token service provider 120.

In response, at 404, the token service provider 120 determines an assurance level associated with the tokenization request. As defined, for example, in Table 1, various factors may be associated with the tokenization request, whereby the token service provider 120 gains assurance that the user 110 is authorized and the user 110 is who he/she says he/she is. Beyond the rules illustrated in Table 1, it should be appreciated that other rules may be employed. The assurance level may be represented numerically, by color, or by relative terms (e.g., high, low, etc.), depending on, for example, the detail intended to be conveyed by the assurance level. In general, when the assurance level is passed to the issuer 108, as described below, the assurance level (or a derivative of the assurance level) should be understandable to the user 110. As such, in various embodiments, readily understood indicators, such as, high, low, may be employed.

The token service provider 120 then generates the token, at 406. In particular, the token may be generated consistent with one or more specifications, including a suitable EMV specification (see, e.g., www.emvco.com, which is incorporated herein by reference), etc.

The token service provider 120 stores, at 408 the generated token, in memory (e.g. the memory 204, etc.) (e.g., a token vault, etc.) and links the assurance level (in memory) to the token, whereby the assurance level may be retrieved based on the token.

In turn, the token and token profile are provisioned for use by the user 110. In addition, as part of the provisioning operation, optionally (as indicated in dotted lines in FIG. 4), at 410, the token may also be provisioned to the merchant 102 for use in card-on-file transactions with the merchant 102. Further, the token may be provisioned to the communication device 111, another device (e.g., a smartphone, a virtual wallet, a smartwatch, a fitness tracker, etc.), or to another entity (e.g., a biometric identity transaction host (e.g., a token store and linked to a biometric to retrieve the token, etc.), etc.).

Once provisioned, the user 110 initiates a transaction with the merchant 102, at 412. The user 110 may provide the token, for example, through a virtual wallet (when provisioned thereto), or may provide a biometric associated with the token, whereby the merchant 102 is permitted to retrieve the token based on the biometric (e.g., from the token service provider 120, etc.), or employ a merchant application to define the transaction (e.g., an in-application transaction, etc.). In response, the merchant 102 (e.g., the terminal 112, or the virtual location 114, etc.) retrieves, at 414, the token (and token profile) for the user's payment account (as provisioned above, for example, from the token service provider 120, from the communication device 111, otherwise, etc.). In connection with the above, it should be appreciated that the user 110 may be requested to verify one or more proofs of identity 122 (e.g., by logging in to the merchant's virtual location 114, by responding to a challenge question associated with enhanced authentication, by providing a biometric, by providing a PIN, etc.), etc.

The merchant 102 then compiles an authorization request for the transaction, at 416, which includes the token. In addition to the token, the merchant 102 (or the terminal 112 or the virtual location 114) may also include further details of the transaction and the verification of the user 110. For example, the authorization request may include a credential source, which may be indicative of whether the token is received from a device (e.g., a virtual wallet, etc.), or as a card-on-file, or from a third party (e.g., a biometric identification transaction host, etc.), or whether the transaction does not involve a token (where the credentials may instead be provided by way of a magstripe or chip associated with the card device 116 or by manual entry, etc.). In addition, the authorization request may include a credential authentication type, which may be indicative of the type of authentication of the credential, and a method of user identification/verification. And, also, the authorization request may include a user validation type, which may include an indication of the type of validator (e.g., issuer, merchant, third party, 3DS, etc.), a specific validation entity (e.g., Bank ABC (as issuer, etc.), and/or a validation risk score (which may provide insight into the confidence in the validation type and/or entity), etc.).

It should be appreciated that other data may be included in the authorization request to more fully define the transaction for the issuer 108, the payment network 106, etc.

As the merchant 102 is responsible for compiling the data into the authorization request, the data described above may be included in any available data element in the authorization request, or potentially, as newly defined in the standard. That said, in this example embodiment, the authorization request is consistent with the ISO 8583 standard, but may be consistent with one or more other interchange messaging standards, or otherwise, etc.

Once compiled, the merchant 102 transmits, at 418, the authorization request to the acquirer 104. The acquirer 104 receives the authorization request and then transmits, at 420, the authorization request to the payment network 106, which passes, at 421, the authorization request to the token service provider 120, in response to the authorization request including a token.

At 422, the token service provider 120 retrieves the credential(s) (e.g., the PAN, etc.) for the token, and also the assurance level linked to the token (when the credential source indicates that the transaction involves the token, etc.). The token service provider 120 then appends, at 424, the credential and the assurance level (in one form or another) to the authorization request. In one or more embodiments, the token service provider 120 (or the payment network 106 more generally) may compile a score associated with the assurance level and/or other data included in the authorization request, to thereby compile the transaction type, validation type and associated data, and the assurance level into specific data. In this manner, the issuer 108 may be permitted to limit interpretation of the data in the authorization request as it relates to transaction type and/or validation of the user 110, etc. Regardless of the form that the assurance level is included in the authorization request, the authorization request is then passed back to the payment network 106, at 425.

The payment network 106 then transmits, at 426, the authorization request to the issuer 108. In response, the issuer 108 decides, at 428, whether to approve or decline the transaction, based, at least in part, on the transaction type included in the authorization request. The issuer 108, in turn, compiles and transmits an authorization reply back to the merchant 102, via the payment network 106 and the acquirer 104. It should be appreciates that the transaction type may further be employed, amongst the issuer 108, the acquirer 104, or the payment network 106 to define or re-define the liability of the transaction for instances where the transaction is fraudulent.

Again, and as previously described, it should be appreciated that the functions described herein, in some embodiments, may be described in computer executable instructions stored on a computer-readable media, and executable by one or more processors. The computer-readable media is a non-transitory computer-readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) generating, by a token service provider, a token for a payment account based on a request from a user, the token including an indicator of a type of transaction for which the token is available for use; (b) provisioning, by the token service provider, the token to a third party, whereby in response to use of the token in a transaction to the payment account, the indicator is included at a first data element of an authorization request for the transaction to the payment account thereby identifying the type of said transaction in the authorization request; (c) receiving, by the token service provider, the authorization request for the transaction to the payment account; (d) retrieving, by the token service provider, a credential for the payment account based on the token and appending the credential to the authorization request; (e) modifying, by the token service provider, the authorization request to include at least one indicator at a second data element different than the first data element, prior to the authorization request being transmitted to an issuer of the payment account; (f) in response to the request from the user and prior to generating the token, determining, by the token service provider, an assurance level based on a credential type and a validation type indicated in the request; (g) storing the token and the assurance level linked to the token; (h) receiving, by the token service provider, the authorization request for the transaction to the payment account including the token; (i) based on the token, retrieving, by the token service provider, a credential for the payment account and the assurance level linked to the token; and (k) modifying, by the token service provider, the authorization request to include the assurance level or derivative thereof, prior to the authorization request being transmitted to an issuer of the payment account.

As will also be appreciated based on the foregoing specification, the above-described embodiments of the disclosure may be implemented using computer programming or engineering techniques including computer software, firmware, hardware or any combination or subset thereof, wherein the technical effect may further be achieved by performing at least one of the following operations: (a) in response to a request to provision a token for a payment account, determining, by a token service provider, an assurance level based on a credential type and a validation type indicated in the request; (b) generating, by the token service provider, the token for the payment account; (c) storing the token and the assurance level linked to the token; (d) provisioning, by the token service provider, the token to a third party, whereby the token is included in an authorization request for a transaction to the payment account; (e) receiving, by the token service provider, the authorization request including the token; (f) based on the token, retrieving, by the token service provider, a credential for the payment account and the assurance level linked to the token; and (g) modifying, by the token service provider, the authorization request to include the assurance level or derivative thereof, prior to the authorization request being transmitted to an issuer of the payment account.

As will also be appreciated based on the foregoing specification, the above-described embodiments of the disclosure may be implemented using computer programming or engineering techniques including computer software, firmware, hardware or any combination or subset thereof, wherein the technical effect may further be achieved by performing at least one of the following operations: (a) receiving, by an acquirer computing device, from a computing device associated with a merchant, an authorization request for a transaction involving the merchant and initiated to a payment account based on a token associated with the payment account, wherein the authorization request includes an indicator of a type of the transaction; (b) modifying, by the acquirer computing device, the authorization request to include the type of the transaction, based on the indicator; and (c) transmitting, by the acquirer computing device, the authorization request to a payment network associated with processing the transaction.

As will also be appreciated based on the foregoing specification, the above-described embodiments of the disclosure may be implemented using computer programming or engineering techniques including computer software, firmware, hardware or any combination or subset thereof, wherein the technical effect may further be achieved by performing at least one of the following operations: (a) receiving, by a computing device associated with a payment network, from an acquirer of a merchant, an authorization request for a transaction involving the merchant and initiated to a payment account based on a token associated with the payment account, wherein the authorization request includes an indicator of a type of the transaction; (b) modifying, by the computing device, the authorization request to include the type of the transaction, based on the indicator; and (c) transmitting, by the computing device, the authorization request to an issuer of the payment account, whereby the issuer approves or declines the transaction based at least in part on the type of the transaction included in the authorization request.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” and the phrase “at least one of” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in identifying types of network interactions, the method comprising:
generating, by a token service provider, a token for a payment account based on a request from a user, the token including an indicator of a type of transaction for which the token is available for use;
provisioning, by the token service provider, the token to a third party, whereby in response to use of the token in a transaction to the payment account, the indicator is included at a first data element of an authorization request for the transaction to the payment account thereby identifying the type of said transaction in the authorization request.

2. The computer-implemented method of claim 1, further comprising:
receiving, by the token service provider, the authorization request for the transaction to the payment account; and
retrieving, by the token service provider, a credential for the payment account based on the token and appending the credential to the authorization request.

3. The computer-implemented method of claim 2, further comprising modifying, by the token service provider, the authorization request to include at least one indicator at a second data element different than the first data element, prior to the authorization request being transmitted to an issuer of the payment account.

4. The computer-implemented method of claim 2, wherein the transaction type is selected from the group consisting of a biometric identity transaction, a card-on-file transaction, and an in-app transaction.

5. The computer-implemented method of claim 2, wherein the third party includes a merchant, and wherein the token is provisioned as an on-file token.

6. The computer-implemented method of claim 2, wherein the third party includes a biometric identification host, and wherein the token is associated with a biometric.

7. The computer-implemented method of claim 6, wherein the type of the transaction to the payment account includes a biometric identification transaction.

8. The computer-implemented method of claim 1, wherein the authorization request is consistent with the ISO 8583 standard and the indicator of the type of transaction for which the token is available for use is included at one of data element 55, data element 22, and data element 61 thereof.

9. The computer-implemented method of claim 1, wherein the indicator of the type of transaction for which the token is available for use is a tag included in an Application Interchange Profile (AIP) data element (DE) of the authorization request.

10. The computer-implemented method of claim 1, further comprising:
in response to the request from the user and prior to generating the token, determining, by the token service provider, an assurance level based on a credential type and a validation type indicated in the request; and
storing the token and the assurance level linked to the token.

11. The computer-implemented method of claim 10, further comprising:
receiving, by the token service provider, the authorization request for the transaction to the payment account including the token;
based on the token, retrieving, by the token service provider, a credential for the payment account and the assurance level linked to the token; and
modifying, by the token service provider, the authorization request to include the assurance level or derivative thereof, prior to the authorization request being transmitted to an issuer of the payment account.

12. The computer-implemented method of claim 10, wherein the authorization request further includes one or more of: a credential source, a credential authentication type, a manner of user identification/verification, and a user validation type.

13. A computer-implemented method for use in identifying types of network interactions, the method comprising:
receiving, by an acquirer computing device, from a computing device associated with a merchant, an authorization request for a transaction involving the merchant and initiated to a payment account based on a token associated with the payment account, wherein the authorization request includes an indicator of a type of the transaction;
modifying, by the acquirer computing device, the authorization request to include the type of the transaction, based on the indicator; and then
transmitting, by the acquirer computing device, the authorization request to a payment network associated with processing the transaction.

14. The computer-implemented method of claim 13, wherein modifying the authorization request includes adding the type of the transaction to a data element of the authorization request.

15. The computer-implemented method of claim 13, wherein the indicator is a tag included in an Application Interchange Profile (AIP) data element (DE) of the authorization request.

16. The computer-implemented method of claim 13, wherein the transaction type is selected from the group consisting of a biometric identity transaction, a card-on-file transaction, and an in-app transaction.

17. A computer-implemented method for use in identifying types of network interactions, the method comprising:
receiving, by a computing device associated with a payment network, from an acquirer of a merchant, an authorization request for a transaction involving the merchant and initiated to a payment account based on a token associated with the payment account, wherein the authorization request includes an indicator of a type of the transaction;
modifying, by the computing device, the authorization request to include the type of the transaction, based on the indicator; and then
transmitting, by the computing device, the authorization request to an issuer of the payment account, whereby the issuer approves or declines the transaction based at least in part on the type of the transaction included in the authorization request.

18. The computer-implemented method of claim 17, wherein modifying the authorization request includes adding the type of the transaction to a data element of the authorization request.

19. The computer-implemented method of claim 17, wherein the indicator is a tag included in an Application Interchange Profile (AIP) data element (DE) of the authorization request.

20. The computer-implemented method of claim 17, wherein the transaction type is selected from the group consisting of a biometric identity transaction, a card-on-file transaction, and an in-app transaction.

21.-42. (canceled)
